(19) United States
(12) Patent Application Publication
(10) Pub. No.: US 2010/0199967 A1
(43) Pub. Date: Aug. 12, 2010

(54) BARBEQUE GRILL HAVING FINS FOR ENHANCED HEAT TRANSFER

(76) Inventor: Martin James Wieczorek, Glendale, AZ (US)

Correspondence Address: Woods Oviatt Gilman LLP, 700 Crossroads Bldg, 2 State St., Rochester, NY, 14614, US

(21) Appl. No.: 12/369,777

(22) Filed: Feb. 12, 2009

(51) Int. Cl. A47J 37/07; F28F 7/00; F24H 3/00

(52) U.S. Cl. 126/25 R; 165/185; 165/47

(57) ABSTRACT

A barbeque grill assembly comprising a grill shell for holding a heating medium such as charcoal or a gas-distribution plenum. The sides of the grill shell support a heat-exchanger grill element above the heating medium, comprising a plurality of slats disposed in a frame and separated by slots, the slats and slots extending across the grill element. The slats are provided with heat conductor fins in contact with the slats and extending vertically downwards into proximity with the heating medium. Each fin has a relatively large surface area exposed to the hot combustion gases that move upwards from the heating medium toward the grill element, such that each fin abstracts heat from the gases and conducts the heat into the grill slats, thereby increasing the amount of heat derived from the combustion gases, increasing the temperature of the grill slats, and thereby increasing the efficiency of the barbeque grill assembly.

### TECHNICAL FIELD

The present invention relates to an apparatus for open-flame cooking of foods, referred to herein generically as a “barbeque grill assembly”; more particularly, to barbeque grill assemblies deriving heat from combustion of a combustible medium such as, for example, gas, charcoal, or combinations thereof; and most particularly, to a heat-exchanger barbeque grill having heat conductor fins attached to the food-supporting grill slats and extending therefrom toward the heating medium for conductive transfer of heat from the heating medium to the grill slats.

### BACKGROUND OF THE INVENTION

Barbeque grill assemblies are well known for cooking food by application of flame heat to a grill element (also referred to herein as a “grill”) supported by a grill shell at a distance above the flame. Typically, the grill element is directly supportive of the food to be cooked, although in some cases the food is suspended above the grill as in rotisserie broiling of meats. In either case, the grill element itself is heated in the prior art solely by convection of hot gases and radiation from the flame below. Food is cooked by a combination of heat extracted from the supporting grill and direct convection from gases reaching the food directly through openings in the grill.

Because transfer of heat from the flame to the grill and the food is limited exclusively to convection and radiation, the achievable cooking temperature is limited. In broiling in the prior art, the grill temperature may be increased by enclosing the grill in a heat-retaining hood, but this action causes the food to bake as well as to broil on the underside, which can be undesirable.

Further, convective heating of the grill and food is relatively inefficient, and a large majority of the heat is wasted in the hot gases that have passed through the grill and past the food and are exhausted to atmosphere. To achieve high grill temperatures suitable for broiling of meat requires an excessively high flow rate of gas or supply of excess charcoal, both of which are costly and wasteful of resources.

What is needed in the art is a grill apparatus that recovers more heat from the flame and transfers that heat into the grill element, thus requiring a smaller flame and less fuel for a given grill surface temperature.

It is a principal object of the present invention to increase the surface temperature of a barbeque grill as compared to a prior art barbeque grill for any given rate of fuel combustion.

### SUMMARY OF THE INVENTION

Briefly described, a barbeque grill assembly in accordance with the present invention comprises a conventional grill shell having a bottom surface for holding a heating medium, either charcoal or, in the case of a gas-fired grill, a gas-distribution plenum and typically a layer of inert material such as pumice gravel. The sides of the grill shell extend upwards from the bottom to support the grill element itself at a distance above the heating medium. A heat-exchanger grill element comprises a plurality of longitudinal slats disposed in a frame and separated by longitudinal slots, the slats and slots typically extending across the shorter dimension of the grill element from front to back of the grill shell. At least some, and preferably all, of the slats are provided with metallic heat conductor fins in intimate contact with the slats and extending vertically downwards into proximity with the heating medium. The heat conductor fins may be connected to the slats in any of a variety of ways. Each fin has a relatively large surface area exposed to the hot combustion gases that move upwards from the heating medium toward the grill element, such that each fin abstracts heat from the gases and conducts the heat into the grill slats, thereby increasing the amount of heat derived from the combustion gases, increasing the efficiency of the barbeque grill, and increasing the temperature of the grill slats.

### BRIEF DESCRIPTION OF THE DRAWINGS

The present invention will now be described, by way of example, with reference to the accompanying drawings, in which:

FIG. 1 is an isometric view from above of a first embodiment of a heat-conductor grill element equipped with conductor fins in accordance with the present invention;

FIG. 2 is an isometric view from below of the first embodiment shown in FIG. 1;

FIG. 3 is a cross-sectional elevational view of an exemplary grill slat equipped with an exemplary heat conductor fin in accordance with the first embodiment; and

FIG. 4 is a cross-sectional elevational view of an exemplary grill slat and heat conductor fin in accordance with a second embodiment of the present invention.

Corresponding reference characters indicate corresponding parts throughout the several views. The exemplifications set out herein illustrate currently preferred embodiments of the invention, and such exemplifications are not to be construed as limiting the scope of the invention in any manner.

### DESCRIPTION OF THE PREFERRED EMBODIMENTS

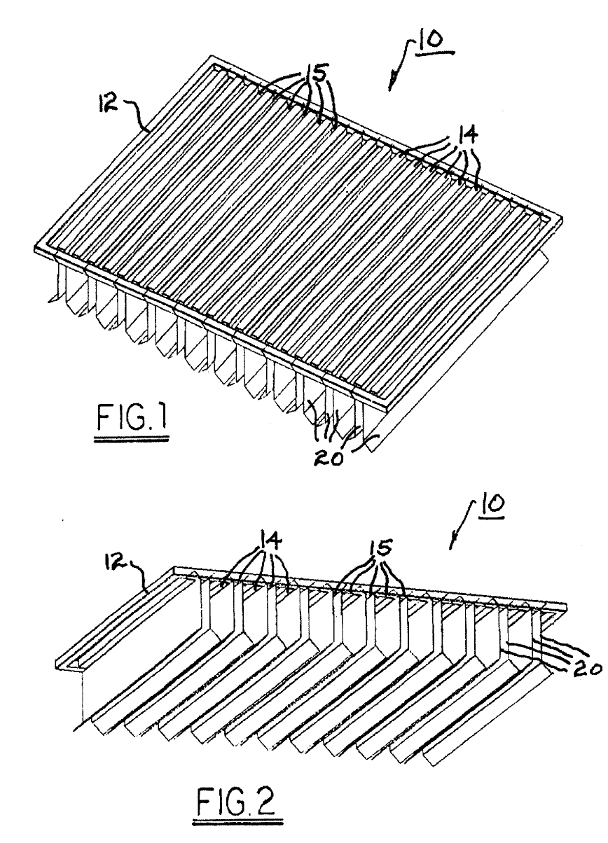

Referring to FIGS. 1 through 3, a heat-exchanger grill element 10 in accordance with a first embodiment of the present invention, for use in a barbeque grill assembly (not shown), comprises a frame 12 surrounding and attached to a plurality of slats 14 spaced apart by slots 15 and extending in parallel array transversely of frame 12 in either the shorter or longer transverse direction. Frame 12 and slats 14 may be formed of any suitable material capable of withstanding barbequing temperatures up to at least 500° C. without distortion, preferably a metal such as steel which may be coated with a ceramic layer for ease in cleaning as may be desired. Each slat 14 is formed having a longitudinal slot 16 terminating optionally in a longitudinal bore 18.

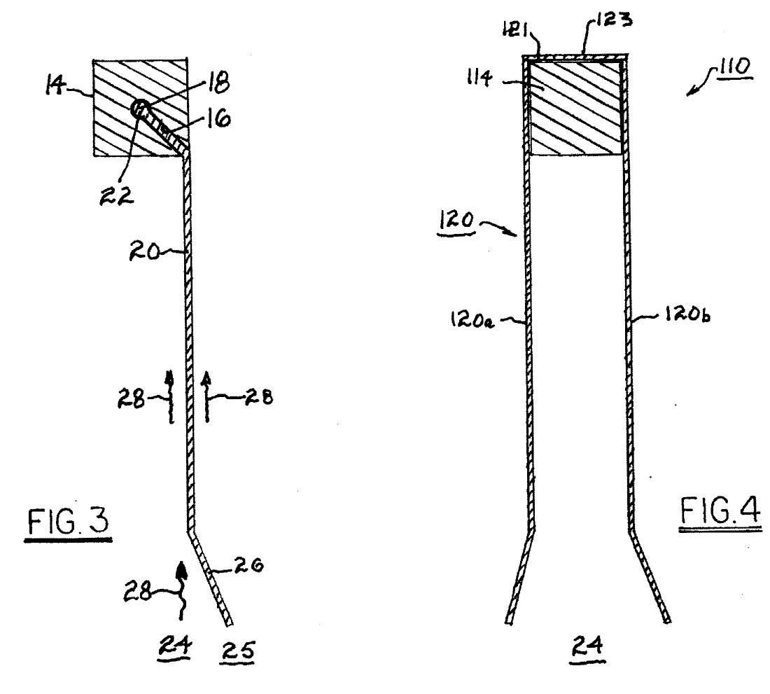

A heat conductor fin 20 is formed from metal to fit into slot 16 as shown in FIG. 3, and optionally may be provided with a longitudinal beaded edge 22 for insertion into bore 18 during assembly. Fin 20 is preferably formed of a metal alloy having relatively high thermal conductivity. Conductor fin 20 is further formed to extend downwards from slat 14 toward heating medium 24 disposed in the bottom of a barbeque grill shell 25 in known fashion, heat-exchanger grill element 10 being supported conventionally by upwardly-extending sides (not shown) of grill shell 25. Fin 20 optionally may be flared 26 as desired to assist in channeling hot gases 28 from heating medium 24 into contact with slat 14. It will be seen that as hot gases 28 travel along the surfaces of each fin 20,26, heat is abstracted from the gases into fins 20 and is conducted thence into slats 14 through contact in slots 16 and bores 18, thus raising the temperature of slats 14 and reducing the amount of waste heat escaping in gases 28 after passing slats 14.

Referring now to FIG. 4, a second embodiment 110 of a heat-exchanger grill element is similar in construction to first embodiment 10. However, the slats 114 and heat conductor fins 120 are constructed somewhat differently. Each slat 114 is formed as a monolith without a slot 16 or bore 18 as in first embodiment 10, and each fin 120 is formed as a U-shaped element having first and second fin elements 120a,120b, joined by a connector 121, that is snapped over a slat 114 and is held in place as by gravity. Preferably, fin 120 is formed as a slightly closed U to grip its respective slat 114 after installation thereupon. In this embodiment, the upper surface 123 of connector 121 becomes the actual cooking surface for the barbeque grill assembly.

An advantage of second fin embodiment 120 is that it is useful in retrofitting an existing barbeque grill element to provide the heat exchanging benefits of the invention. Accordingly, an aftermarket exists for a packet of second embodiment fins 120, and no other modification of an existing barbeque grill assembly is required.

Alternately, as a lesser preferred embodiment, a single fin 120a or 120b may be joined to connector 121. Connector 121 is then snapped over slat 114 and only one leg of embodiment 120 extends toward the heating medium 24.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A heat-exchanger barbeque grill element comprising:
a) a plurality of longitudinal slats separated by intervening longitudinal slots; and
b) a plurality of heat conductor fins attached respectively to said plurality of longitudinal slats.

2. A grill element in accordance with claim 1 further comprising a frame for supporting said plurality of slats in spaced-apart arrangement.

3. A grill element in accordance with claim 1 wherein said slats are formed of metal.

4. A grill element in accordance with claim 3 wherein said metal slats are provided with a ceramic coating.

5. A grill element in accordance with claim 1 wherein at least one of said slats includes a longitudinal slot for receiving a portion of a heat conductor fin.

6. A grill element in accordance with claim 5 wherein said slot further includes a longitudinal bore for receiving a beaded edge of said fin portion.

7. A grill element in accordance with claim 1 wherein at least one of said heat conductor fins is formed as a U-shaped element having at least one fin element joined to a connector.

8. A grill element in accordance with claim 7 wherein said at least one fin element comprises first and second fin elements joined by said connector.

9. A heat conductor fin for a barbeque grill wherein said fin is formed as a U-shaped element having at least one fin element joined to a connector

10. A barbeque grill assembly, comprising:
a) a grill shell for supporting a heating medium on a bottom surface thereof; and
b) a heat-conductor barbeque grill element supported by said grill shell apart from said bottom surface, and having a plurality of slats separated by intervening slots, and a plurality of heat conductor fins attached respectively to said plurality of slats and extending from said slats toward said bottom surface.

11. A barbeque grill assembly in accordance with claim 10 wherein at least one of said slats includes a longitudinal slot for receiving a portion of a heat conductor fin.

12. A barbeque grill assembly in accordance with claim 10 wherein at least one of said heat conductor fins is formed as a U-shaped element having at least one fin element joined to a connector.
